(19) United States
(12) Patent Application Publication
(10) Pub. No.: US 2011/0292658 A1
(43) Pub. Date: Dec. 1, 2011

(54) Optical light emitting device

(75) Inventor: Yen-Wei Ho, Taichung (TW)

(73) Assignee: GENIUS ELECTRONIC OPTICAL CO., LTD.

(21) Appl. No.: 12/805,154

(22) Filed: Jul. 15, 2010

(30) Foreign Application Priority Data
May 28, 2010 (TW) 099210186

(51) Int. Cl. F21V 7/00

(52) U.S. Cl. 362/307

(57) ABSTRACT

An optical light emitting device comprises a circuit substrate having a plurality of LED lamps arranged as an array; a plurality of optical lenses correspondingly installed to light extraction portions of the plurality of LED lamps, the optical lens having a platform that is equipped with an incident concave surface for containing the LED lamp, a light extracting convex surface disposed to a corresponding exterior end of the incident concave surface; and a reflector having a plurality of containing holes arranged as an array capable of corresponding to the LED lamps array of the circuit substrate, each containing hole provided for fitting the light extracting convex surface of the optical lens, expansion inclined planes with an upper-wide and lower-narrow shape disposed to a periphery of the containing hole, the platform of the optical lens leaning against a frame border of the containing hole.

### FIELD OF THE INVENTION

The present invention relates to an optical light emitting device, and more particularly to an optical light emitting device applied to a road lamp for illumination.

### BACKGROUND OF THE INVENTION

According to Taiwan patent publication number: 201002990 “A structure for enhancing lighting effect of LED lamp”, its independent claim 1 discloses that an aluminum substrate having a central area printed with interlaced circuit wires is taken as a main body, several screw holes are disposed to a periphery, and several LEDs (light emitting diode) are installed on the circuit wires based upon predetermined positions, and transparent resin is coated on the LED, and the characterized is in that: a honeycomb reflector is assembled by arranging containing holes with the same size while corresponding to a pattern array of the LEDs. Inclined plates having smooth surfaces and upward gradients are disposed to a periphery of each containing hole. An aspheric glass cover is a curved lens having an edge extended from thereof. A frame border is a hollow ring body having stair layers, wherein its bottom having through holes, and an upper layer is higher than a bottom layer.

Accordingly, \the refraction can pass through the curved lens as the aspheric glass cover to increase the illumination range. The honeycomb reflector then reflects remaining light emitted by the LEDs, and the reflected light beam returning to the inside is further reflected by the total reflection of the aspheric glass cover to adequately utilize the reflected light beam to increase the light input. Simultaneously, a portion of heat generated by the LED is conducted and dissipated to comply with the installation of various lamps. The reflected light beam can be reused to achieve the goal of enhancing the light-emitting efficiency.

The foregoing entire structure utilizes the inclined plates of each containing hole of the honeycomb reflector to reflect remaining light emitted from a side of the LED contained in the containing hole to increase the light output.

However, the foregoing structure utilizes single aspheric glass cover with the large size to cover the honeycomb reflector and the plurality of LEDs contained in the containing holes so that the light beam reflected by the inclined plates from the LED must be diffused and refracted by the aspheric glass cover again. More specifically, most light bean reflected by the inclined plates is guided to the exterior periphery of the aspheric glass cover. Accordingly, the remaining light integrated by the aspheric glass cover is more uniform. However, the existing defect is that the light beam refracted by the structure is unable to be integrated and projected to a predetermined angle range. If the structure is applied to a road lamp, the remaining light guided by the aspheric glass cover may cause light pollution that will influence neighbor houses.

Accordingly, to overcome the foregoing shortcomings, the inventor(s) of the present invention based on years of experience in the related field to conduct extensive researches and experiments, and finally invented an optical light emitting device.

### SUMMARY OF THE INVENTION

A primary objective of the present invention is to provide an optical light emitting device applied to a road lamp for illumination and capable of controlling the projection angle of the light beam to further prevent neighbor houses from being interfered with light pollution from remaining light of the road lamps.

To achieve the foregoing objective, the optical light emitting device provided by the present invention firstly utilizes at least one optical lens to uniformly refract light beams with the maximum optical energy of the LED lamps to a projection angle range that satisfies rules and regulations and then uses a reflector correspondingly fitting an exterior of the optical lens to reflect and to guide remaining light refracted by a side of the optical lens into a predetermined projection area. The design does not only adequately utilize the remaining light from smaller angles of the LED lamp, but also effectively prevents the light pollution generated from a side of the LED lamp.

Taking the foregoing arranged structure as a basis, multiple sets of optical light emitting devices can be assembled to a lamp holder of a road lamp to achieve the illumination brightness of the road lamp satisfying laws and regulations.

### BRIEF DESCRIPTION OF THE DRAWINGS

FIG. 1 is a decomposition drawing of a structure according to a preferred embodiment of the present invention;

FIG. 2 is an assembly drawing of a structure according to a preferred embodiment of the present invention;

FIG. 3 is an assembled top view of a structure according to a preferred embodiment of the present invention;

FIG. 4 is a cross-sectional drawing A-A according to FIG. 3; and

FIG. 5 is a schematic diagram of a structure assembled to a lamp holder of a road lamp according to a preferred embodiment of the present invention.

### DETAILED DESCRIPTION OF THE PREFERRED EMBODIMENTS

Other features and advantages of the present invention will become apparent from the following description of the invention which refers to the accompanying drawings.

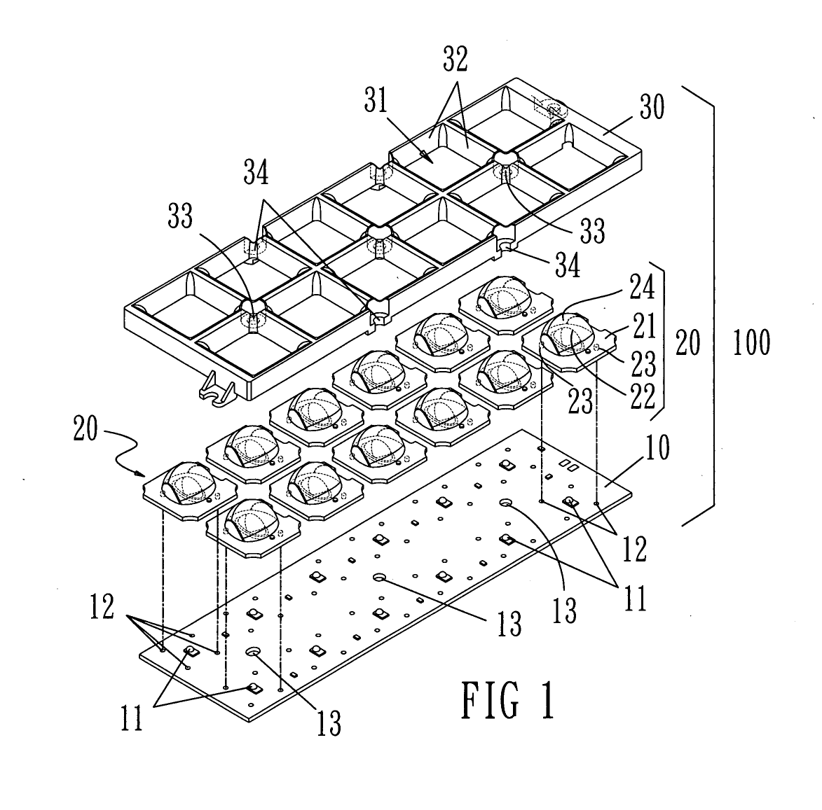

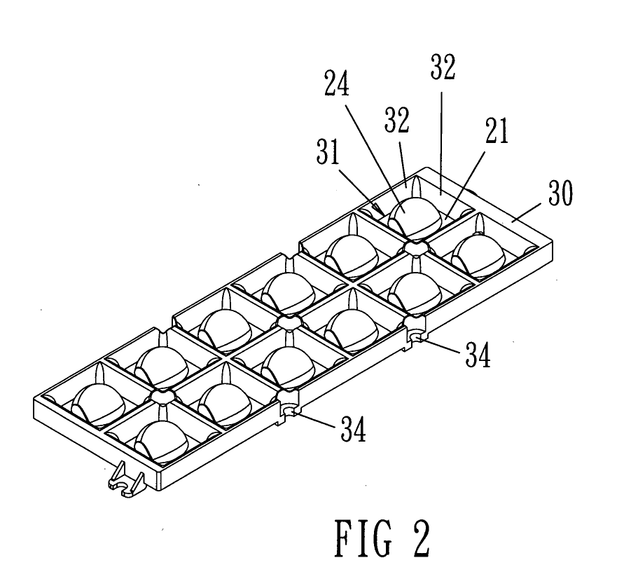

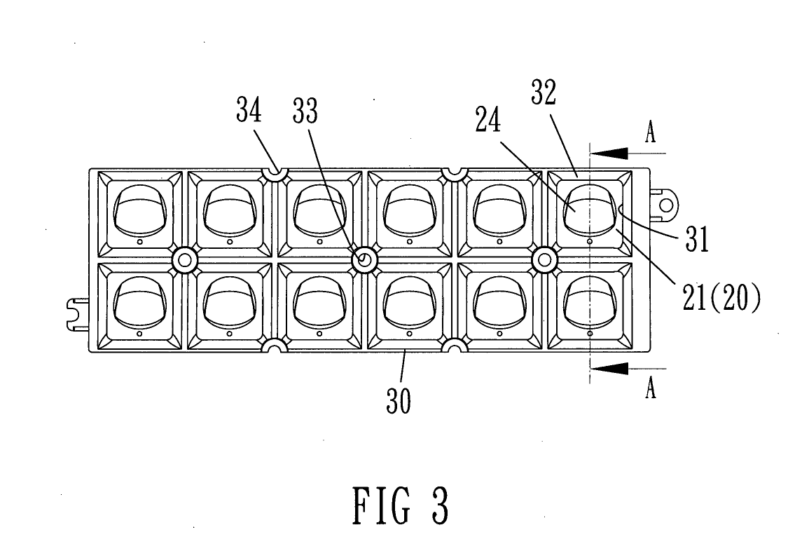

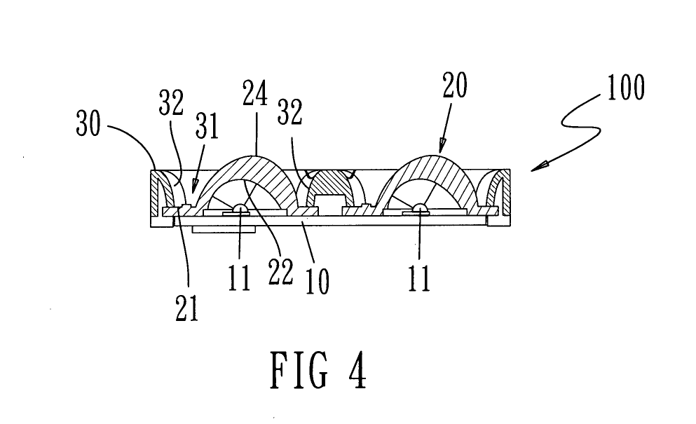

First, please refer to FIG. 1 to FIG. 4, an optical light emitting device 100 of the present invention mainly comprises a circuit substrate 10, a plurality of optical lenses 20 and a reflector 30.

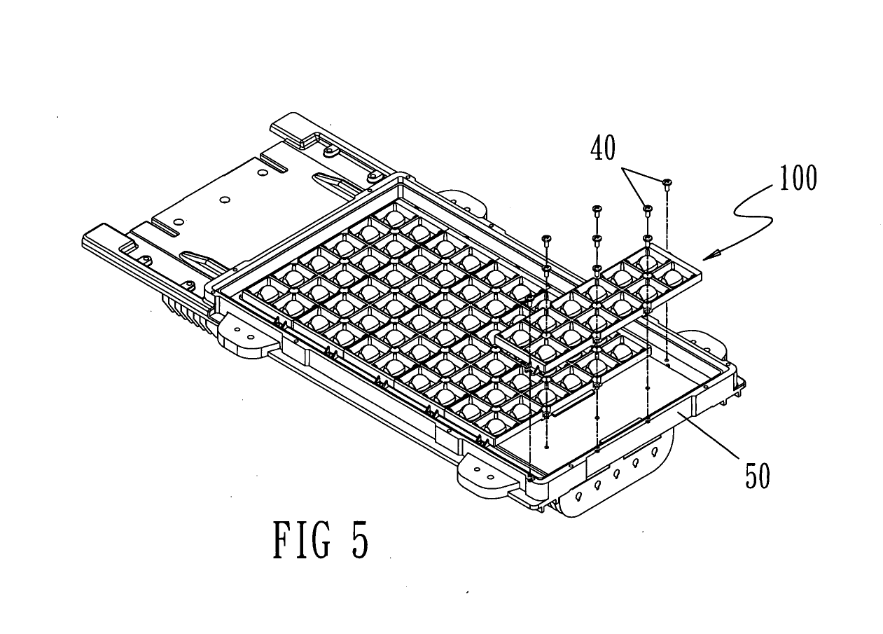

The circuit substrate 10 has a plurality of LED lamps 11 arranged as an array. A proper distance is between adjacent LED lamps 11. The circuit board 10 has a plurality of positioning holes 12 disposed to an exterior periphery of each LED lamp 11. The positioning holes 12 are passed by correspondingly foot cylinders 23 of the optical lenses 20, and the circuit substrate 10 has a plurality of locking holes 13 for containing locking components 40 to install and to lock on a lamp holder 50 (as shown in FIG. 5) of a road lamp. In the embodiment, the circuit substrate 10 is designed as a rectangle plate body, wherein its longer side direction has two rows of LED lamp sets. Each row of LED lamps is composed of a plurality of LED lamps 11 spaced at proper intervals so as to form a rectangular array pattern. In addition, the array patterns arranged by the plurality of LED lamps 11 can be replaced with a concentric circle array or an elliptic array.

The plurality of optical lenses 20 correspond to the amount of the plurality of LED lamps 11 on the circuit board 10 and respectively correspond to a light extraction portion of each LED lamp 11. The optical lens 20 has a platform 21. An incident concave surface 22 is disposed to a central portion of the platform 21 to contain the LED lamp 11. A bottom of the platform 21 has a plurality of foot cylinders 23 located to an exterior periphery of the incident concave surface 22. A light extracting convex surface 24 is disposed to a corresponding exterior end of the incident concave surface 22. The incident concave surface 22 and the light extracting convex surface 24 are composed of contacting several elliptical curved surfaces. The foot cylinders 23 protruded from the bottom of the platform 21 can firstly embed in the predetermined positioning holes 12 on the circuit substrate 10 surrounding the exterior periphery of the LED lamps 11 to rapidly complete the initial installation and positioning while in assembly.

The reflector 30 has a plurality of containing holes 31 arranged as an array, and the containing holes 31 correspond to the LED lamps array 11 of the circuit substrate 10. The light extracting convex surface 24 of the optical lens 20 can contain in each containing hole 31, and expansion inclined planes 32 with an upper-wide and lower-narrow shape are formed at a periphery of the containing hole 31. A frame border at the bottom of the containing hole 31 can press and position the platform 21 of the optical lens 20. Central frame border of the reflector 30 has a plurality of through holes 33. The plurality of through holes 33 can align of the plurality of locking holes 13 of the circuit substrate 10 to incorporate with the locking components 40 to assemble them on the lamp holder 50 (as shown in FIG. 5) of the road lamp. The reflector 30 has multiple sets of symmetrically semicircular through holes 34 along two longer frame borders of the reflector 30. Adjacent semicircular through holes can be assembled as a circular through hole after adjacent longer sides of two reflector 30 lean against with each other. The locking components 40 can pass foregoing through holes to achieve the simultaneous locking. The height of the reflector 30 is lower than the total height of the light extracting convex surface 24 of the optical lens 20.

With the assembly of the foregoing components, remaining light with small angles refracted by a side of the optical lens 20 from the LED lamp 11 then is refracted and guided by the expansion inclined planes 32 of the containing hole 31 to a predetermined projection range after the light beam generated by each LED lamp 11 is refracted by the optical lens 20 to a predetermined projection range. It does not adequately utilize the remaining light to increase the light output, but also isolates the remaining light by using the expansion inclined planes 32 of the containing hole 31, thereby preventing the light pollution.

Moreover, as shown in FIG. 5, an implementation diagram for multiple sets of optical light emitting devices 100 locked to the lamp holder 50 of the road lamp is depicted by incorporating the plurality of locking components 40. With the design of the optical light emitting device 100 of the invention, the light beam of the LED lamp 11 can be reflected and refracted by the incident convex surfaces 22 and the light extracting convex surfaces 24 of the optical lenses 20 so that the light beam can satisfy the features required by the road illumination lamp, wherein the features are that the luminosity is vertical angle 60 degrees and the horizontal angle 65-95 degrees, and the luminous intensity is greater than 300 cd/klm. The remaining light refracted by a periphery of the optical lens 20 can be further isolated by the expansion inclined planes 32 of the containing hole 31 of the reflector 30. Accordingly, the houses near the road lamps can be effectively prevented by light pollutions.

Although the features and advantages of the embodiments according to the preferred invention are disclosed, it is not limited to the embodiments described above, but encompasses any and all modifications and changes within the spirit and scope of the following claims.

What is claimed is:

1. An optical light emitting device comprising: a circuit substrate having a plurality of LED (light emitting diode) lamps arranged as an array, the characterized in that:
a plurality of optical lenses correspondingly installed to light extraction portions of the plurality of LED lamps, the optical lens having a platform, incident concave surfaces disposed to the platforms to contain the LED lamps, light extracting convex surfaces disposed to corresponding exterior ends of the incident concave surfaces; a reflector having a plurality of array containing holes corresponding to the LED lamps array of the circuit substrate, each containing hole provided for fitting the light extracting convex surface of the optical lens, expansion inclined planes with an upper-wide and lower-narrow shape disposed to a periphery of the containing hole to refract remaining light passing through a side of the optical lens from the LED lamp, the platform of the optical lens leaning against a frame border of the containing hole to achieve a positioning.

2. The optical light emitting device as claimed in claim 1, wherein the circuit substrate has a plurality of positioning holes disposed to an exterior periphery of each LED lamp, and the optical lens has a plurality of foot cylinders, which are disposed to a bottom of the platform, for mutually fitting the positioning holes.

3. The optical light emitting device as claimed in claim 1, wherein the circuit substrate has a plurality of locking holes, and the reflector has a plurality of through holes aligning the plurality of locking holes, and locking component pass through the locking holes and the through holes to assemble to a lamp holder of a road lamp.

4. The optical light emitting device as claimed in claim 1, wherein a height of the reflector is lower than a height of the light extracting convex surface of the optical lens.
